(19) United States
(12) Patent Application Publication
(10) Pub. No.: US 2007/0285391 A1
(43) Pub. Date: Dec. 13, 2007

(54) Peripheral device

(76) Inventors: Kiyotada Yokogi, Tokyo (JP); Hiroyuki Takamatsu, Kanagawa (JP); Kohei Mori, Kanagawa (JP); Takashi Mizoroki, Kanagawa (JP); Kenji Asakura, Fukui (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/711,344

(22) Filed: Feb. 27, 2007

(30) Foreign Application Priority Data
Mar. 9, 2006 (JP) 2006-063787

(51) Int. Cl. G09G 5/00; G06F 3/033

(52) U.S. Cl. 345/163; 345/156

(57) ABSTRACT

Disclosed herein is a peripheral device connected to an electronic device via an interface cable for exchanging first data with the electronic device via the interface cable based on a general interface standard. The peripheral device includes a radio communication section configured to perform radio communication with an outside and exchange second data relating to the radio communication with the electronic device via the interface cable based on the general interface standard.

### CROSS REFERENCES TO RELATED APPLICATIONS

The present invention contains subject matter related to Japanese Patent Application JP 2006-063787, filed in the Japanese Patent Office on Mar. 9, 2006, the entire contents of which being incorporated herein by reference.

### BACKGROUND OF THE INVENTION

1. Field of the Invention

The present invention relates to a peripheral device for an electronic device.

2. Description of the Related Art

An electronic device for reproducing music data recorded on a storage medium, such as a memory or a hard disk drive, includes a main body and headphones. The main body includes a reproduction section for reproducing the music data, a control section for controlling the reproduction section, and an operation section for performing various operations. The headphones are connected to the main body via a cable, and outputs sound based on an audio signal outputted from the reproduction section.

As one of such electronic devices, there is an electronic device that has included in its main body a tuner section for receiving a broadcasting radio wave transmitted from a radio broadcasting station or the like. In this electronic device, an audio signal obtained by the tuner section demodulating the broadcasting radio wave is supplied to the headphones to output sound.

However, such an electronic device contains various electronic circuits, which act as noise sources. Electromagnetic noises radiating from the noise sources affect the tuner section, making it difficult to ensure a high carrier-to-noise ratio (C/N ratio) of the tuner section.

As such, there has been proposed a technique of having the tuner section contained in a remote control that is provided at the middle of the cable and used for controlling various operations (starting reproduction, stopping reproduction, adjusting the volume, etc.) performed in the main body of the electronic device. According to this technique, since the tuner section is located at a distance from the noise sources in the main body of the electronic device, the C/N ratio of the tuner section is improved (see Japanese Patent Laid-Open No. Hei 11-232852).

### SUMMARY OF THE INVENTION

In the above-described related art technique, however, a signal (audio signal) received and generated at the tuner section can be supplied only to the headphones. In other words, the above-described related art technique does not allow supplying the signal to the main body of the electronic device to use it therein.

In order to enable the use of such a signal received and generated at the tuner section in the main body of the electronic device, a dedicated interface will be newly required to transfer the signal between the remote control and the main body of the electronic device, but provision of the dedicated interface will lead to a high cost. Specific examples of the dedicated interface include hardware components such as a wire and a connector used for signal transfer and software for a controller for the transfer of the signal.

Further, such remote controls are inevitably designed exclusively for their own associated electronic devices, and therefore it is difficult to connect such a remote control to various types of electronic devices for use. In short, there is a problem of lack of versatility.

An advantage of the present invention is to provide a peripheral device that ensures a high C/N ratio of a radio communication section and has an excellent versatility while maintaining a cost at a low level.

According to one embodiment of the present invention, there is provided a peripheral device connected to an electronic device via an interface cable for exchanging first data with the electronic device via the interface cable based on a general interface standard, the peripheral device including a radio communication section configured to perform radio communication with an outside and exchange second data relating to the radio communication with the electronic device via the interface cable based on the general interface standard.

According to this embodiment of the present invention, the radio communication section is contained not within the electronic device but within the peripheral device that is located at a distance from the electronic device. This reduces the effect on the radio communication section of noise that is produced from a noise source in the electronic device, and therefore greatly contributes to improving a reception sensitivity of the radio communication section and maintaining a high C/N ratio thereof.

In addition, since communication data and control data can be transferred via the interface cable based on the general interface standard, there is not a need for a dedicated hardware or software component, which contributes to reducing a cost. Further, since the peripheral device can be connected to any electronic device that complies with the general interface standard, the peripheral device is highly versatile.

### BRIEF DESCRIPTION OF THE DRAWINGS

FIG. 1 is an illustration showing a personal computer and a mouse connected to each other;

FIG. 2 is a block diagram illustrating structures of the personal computer and the mouse;

FIG. 3 is a block diagram illustrating the structure of the mouse;

FIG. 4 is an illustration showing a music player and a remote control connected to each other; and

FIG. 5 is a block diagram illustrating structures of the music player and the remote control.

### DETAILED DESCRIPTION OF THE PREFERRED EMBODIMENTS

### First Embodiment

Hereinafter, embodiments of the present invention will be described with reference to the accompanying drawings.

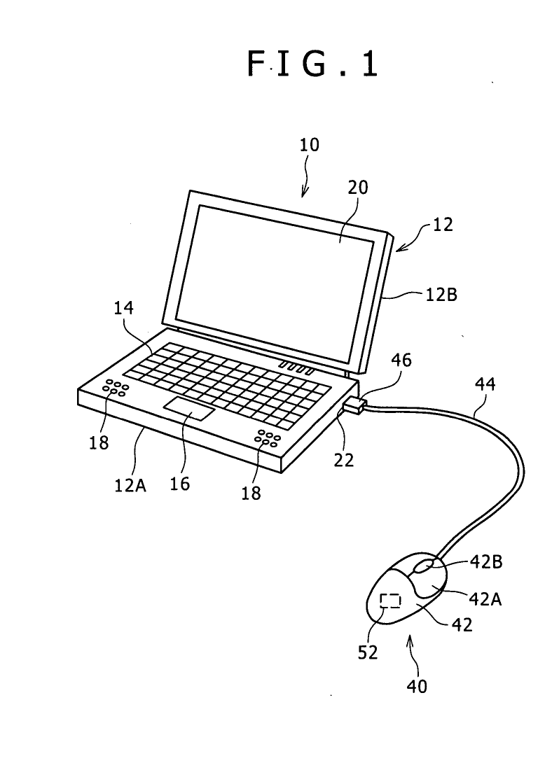

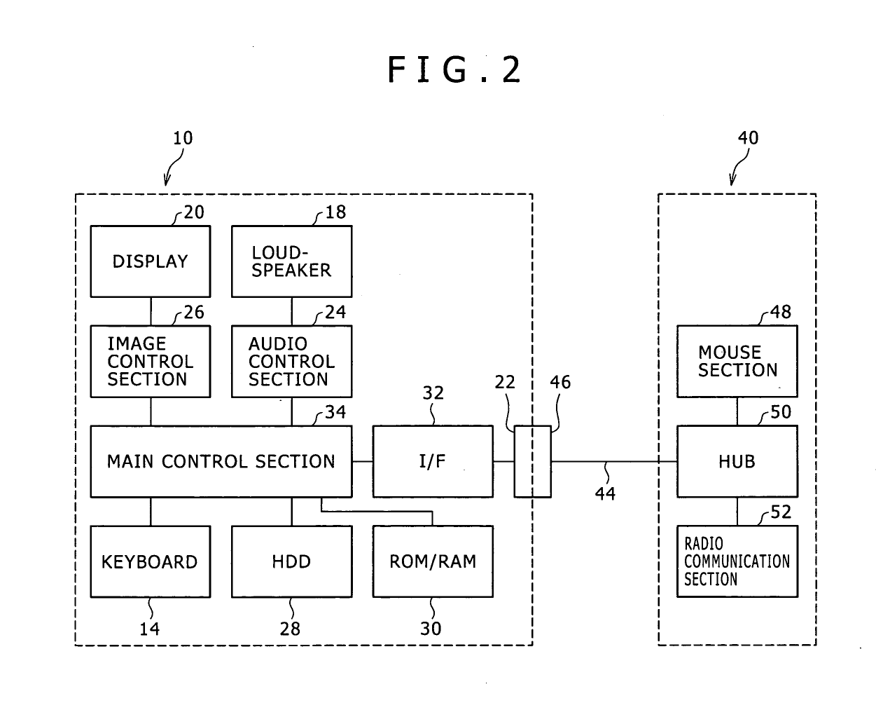

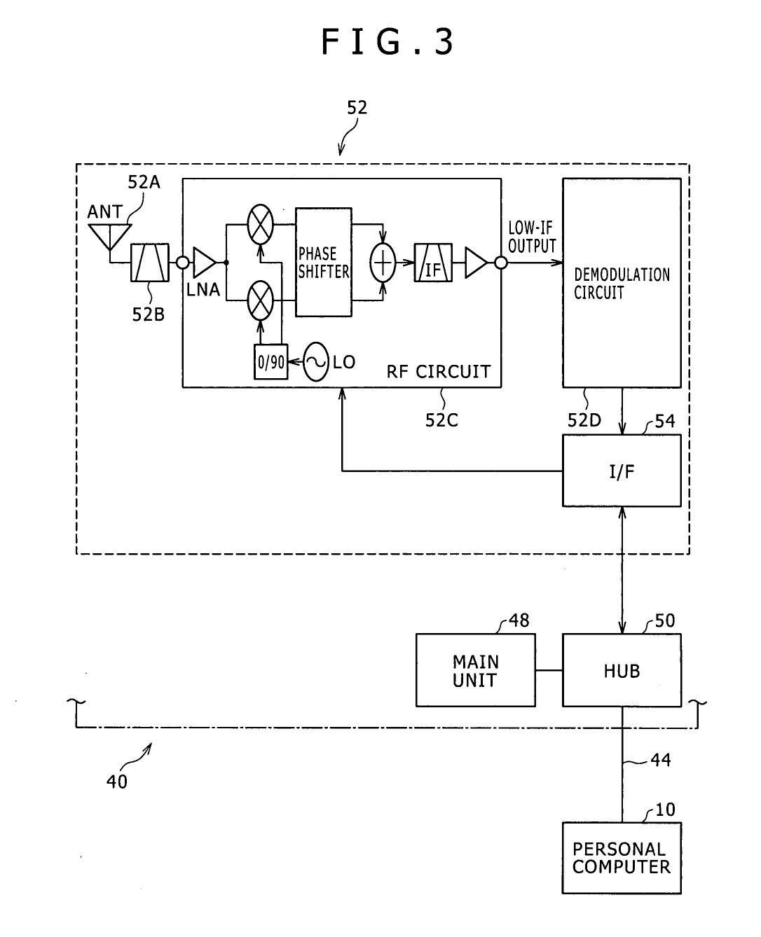

FIG. 1 is an illustration showing a personal computer 10 and a mouse 40 connected to each other. FIG. 2 is a block diagram illustrating structures of the personal computer 10 and the mouse 40. FIG. 3 is a block diagram illustrating the structure of the mouse 40.

An electronic device according to the present embodiment is the notebook personal computer 10, and a peripheral device according to the present embodiment is the mouse 40 for operating the personal computer 10.

First, the personal computer 10 will now be described below.

In FIG. 1, the personal computer 10 includes a case 12. The case 12 includes a first case 12A and a second case 12B that is joined to one side of the first case 12A via a hinge. The case 12 undergoes opening and closing, alternating between a folded state and an unfolded state. The folded state refers to a state in which the first case 12A and the second case 12B are folded together, while the unfolded state refers to a state in which the first case 12A and the second case 12B are unfolded as illustrated in FIG. 1.

A keyboard 14, a touchpad 16, and a loudspeaker 18 for producing sound are provided on an inside surface of the first case 12A that faces the second case 12B.

A display 20, such as a liquid crystal display device, is provided on an inside surface of the second case 12B that faces the first case 12A.

An interface connector 22 is provided on one side of the first case 12A.

As illustrated in FIG. 2, the case 12 contains an audio control section 24, an image control section 26, a hard disk drive 28, a memory 30, an interface section 32, and a main control section 34.

The audio control section 24 generates an audio signal based on audio data supplied from the main control section 34, and supplies the generated audio signal to the loudspeaker 18 to output the sound via the loudspeaker 18.

The image control section 26 generates an image signal based on image data supplied from the main control section 34, and supplies the generated image signal to the display 20 to display an image on the display 20.

The hard disk drive 28 stores various data and programs.

The memory 30 includes a RAM that provides a work area and a ROM that stores various data.

The interface section 32 is connected to the mouse 40 via the interface connector 22 to manage data exchange.

In the present embodiment, the interface section 32 conducts the data exchange based on a Universal Serial Bus (USB) standard, which is a general interface standard (i.e., a standard peripheral interface).

The main control section 34 includes a CPU that operates based on a program loaded from the hard disk drive 28 to the RAM, and exercises control over the keyboard 14, the hard disk drive 28, the memory 30, the audio control section 24, the image control section 26, and the interface section 32.

In the hard disk drive 28, application software for television viewing and driver software for using the mouse 40 have been installed previously.

By executing the application software, the main control section 34 causes the display 20 to display an image based on communication data (which corresponds to second data as recited in the appended claims) sent from a radio communication section 52 contained in the mouse 40, and also causes the loudspeaker 18 to output the sound based on the communication data. In addition, based on a user operation performed on the keyboard 14 or the mouse 40, the main control section 34 supplies, to the radio communication section 52, control data (which corresponds to the second data as recited in the appended claims) for causing the radio communication section 52 to select a television station, for example.

Next, the mouse 40 will now be described below.

In FIG. 1, the mouse 40 has a case 42. One end of an interface cable 44 is connected to the case 42. A USB interface connector 46 is provided at the other end of the interface cable 44. The interface connector 46 is constructed to be detachably connected to the interface connector 22 of the personal computer 10.

As illustrated in FIG. 1, the mouse 40 includes an operation section composed of a button 42A used for clicking and a wheel 42B which are provided on an upper surface of the case 42, and a detection mechanism (not shown) provided at a position at which the case 42 touches a plane on which the mouse 40 is placed for detecting a distance and direction of movement.

In addition, as illustrated in FIG. 2, the case 42 of the mouse 40 contains a main unit 48, a hub 50, and the radio communication section 52.

The main unit 48 generates operation data (which corresponds to first data as recited in the appended claims) generated by the operation section and the detection mechanism as a signal based on the USB standard, and supplies the generated signal (i.e., the operation data) to the personal computer 10 via the hub 50.

The hub 50 has one end of the interface cable 44 connected thereto, and relays a plurality of types of USB signals.

The radio communication section 52 performs radio communication with an outside, and exchanges the second data relating to the radio communication with the personal computer 10 via the interface cable 44 based on the general interface standard.

As illustrated in FIG. 3, in the present embodiment, the radio communication section 52 is a tuner for receiving a broadcasting radio wave of one-segment broadcasting in terrestrial digital broadcasting.

The radio communication section 52 includes an antenna 52A, a filter 52B, an RF circuit 52C, a demodulation circuit 52D, and an interface section 54.

The antenna 52A receives radio waves within a frequency band of the terrestrial digital broadcasting. The antenna 52A is, for example, a chip antenna contained inside the case 42 of the mouse 40.

The filter 52B extracts a radio wave within a band of the terrestrial digital broadcasting from the radio waves received by the antenna 52A, and outputs the extracted radio wave as a reception signal. Note that the reception signal has been modulated according to an orthogonal frequency division multiplex (OFDM) system.

The RF circuit 52C subjects the reception signal supplied from the filter 52B to quadrature demodulation to convert the reception signal into an intermediate frequency (Low-IF) signal, and outputs the resultant intermediate frequency signal. The RF circuit 52C is a known circuit.

The demodulation circuit 52D demodulates the intermediate frequency signal to output MPEG-2 data (which corresponds to the second data as recited in the appended claims) containing image data and audio data, i.e., the communication data, in a transport stream.

The interface section 54 converts the MPEG-2 data (i.e., the communication data) supplied from the demodulation circuit 52D into a signal based on the USB standard, and supplies the resultant signal to the hub 50.

The signal (i.e., the communication data) supplied to the hub 50 is supplied to the personal computer 10 via the interface cable 44.

In addition, the interface section 54 supplies the control data supplied from the personal computer 10 via the interface cable 44 and the hub 50 to the RF circuit 52 to allow the RF circuit 52 to perform channel selection or the like.

Note that the radio communication section 52 may operate, receiving power (i.e., so-called bus power) from the personal computer 10 via the interface cable 44 and the USB hub 50. Alternatively, it may be so arranged that a battery is provided within the mouse 40 and that power is supplied from the buttery to the radio communication section 52.

Next, an operation will now be described below.

When the mouse 40 is used as an ordinary mouse, the interface connector 46 of the mouse 40 is connected to the interface connector 22 of the personal computer 10 as illustrated in FIG. 1.

At this time, any given application software is running on the personal computer 10.

If, in this situation, the mouse 40 is moved on the plane on which the mouse 40 is placed, the operation data is supplied from the mouse 40 to the personal computer 10 so that a cursor displayed on the display 20 is moved, for example. Similarly, if the button 42A used for clicking or the wheel 42B is manipulated, a predetermined operation is carried out.

When the mouse 40 is used as a TV tuner, the interface connector 46 of the mouse 40 is similarly connected to the interface connector 22 of the personal computer 10.

At this time, the application software for television viewing is running on the personal computer 10.

In this situation, a user operates the keyboard 14 of the personal computer 10 or the mouse 40 to supply the control data to the radio communication section 52 to select a desired television station.

The radio communication section 52 generates reception data based on the received broadcasting radio wave, and supplies the generated reception data to the personal computer 10 via the interface cable 44.

The main control section 34 of the personal computer 10 receives the reception data via the interface cable 44 and the interface section 32, and supplies the reception data to the audio control section 24 and the image control section 26.

The audio control section 24 generates the audio signal based on the reception data and supplies the generated audio signal to the loudspeaker 18, so that sound of a television broadcast is outputted.

The image control section 26 generates the image signal based on the reception data and supplies the generated image signal to the display 20, so that an image of the television broadcast is displayed.

Here, the audio control section 24, the image control section 26, the interface section 32, and the main control section 34, which form a part of the personal computer 10, include the CPU or an LSI, which causes noise.

A clock signal for operation of the CPU and a bus clock signal for USB data communication tend to be the noise. The clock signals themselves, multiplied waves of the clock signals, a mixture of the clock signal and the multiplied wave, etc., cause the noise. In particular, a clock signal having a steep waveform causes broadband noise.

In the case of the mouse 40 according to the present embodiment, however, the radio communication section 52 is contained not in the personal computer 10 but in the case 42, which is located at a distance from the personal computer 10. Accordingly, the effect on the radio communication section 52 of the noise caused in the personal computer 10 is reduced. This contributes greatly to improving a reception sensitivity of the radio communication section 52 and maintaining a high C/N ratio thereof. As a result, the television broadcast can be enjoyed with excellent sound and image quality.

In addition, in the case of the mouse 40 according to the present embodiment, the communication data and the control data can be transferred via the interface cable 44 based on the general interface standard, and there is no need for a dedicated hardware or software component, which contributes to reducing the cost. Further, since the mouse 40 can be connected to any electronic device that complies with the general interface standard, the mouse 40 is highly versatile.

Further, since there is no need for the interface cable 44 to carry a special signal, the interface cable 44 may be any cable compliant with the general interface standard, which contributes to reducing the cost. Still further, the hub 50 may be any general hub available on the market, which contributes to reducing the cost.

### Second Embodiment

Next, a second embodiment of the present invention will now be described below.

The second embodiment is different from the first embodiment in that the electronic device is a music player 60 and that the peripheral device is a remote control 80.

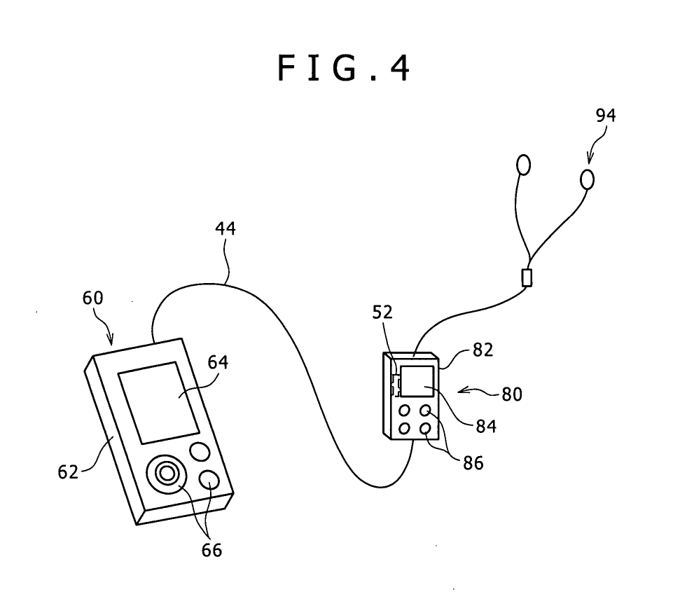

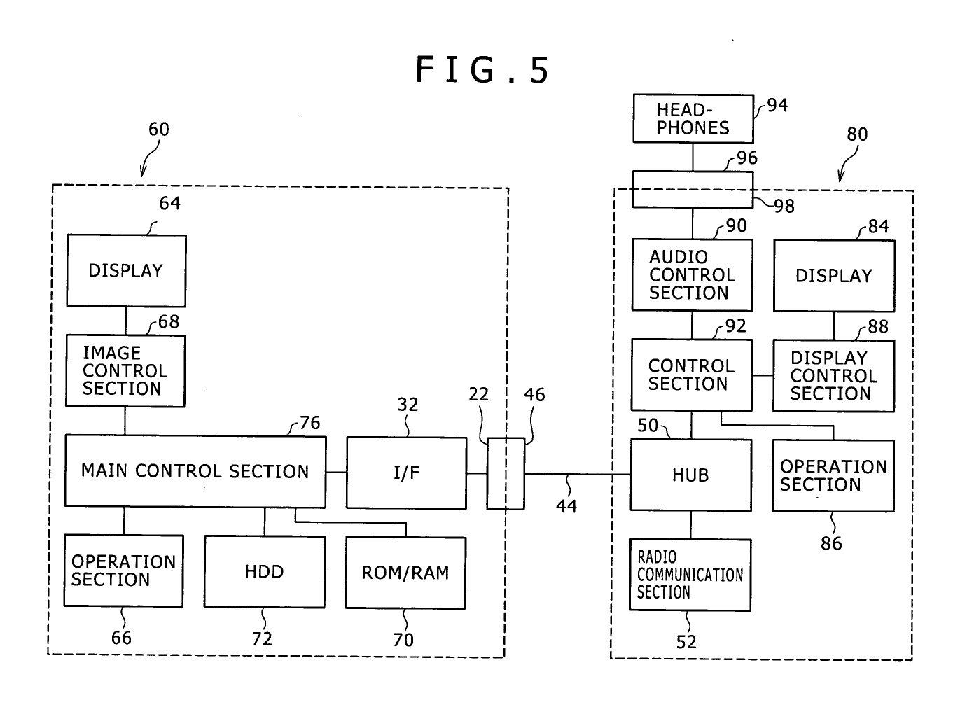

FIG. 4 is an illustration showing the music player 60 and the remote control 80 connected to each other. FIG. 5 is a block diagram illustrating structures of the music player 60 and the remote control 80.

In the present embodiment, elements or components identical to those of the first embodiment are denoted by the same reference numerals as in the first embodiment.

First, the music player 60 will now be described below.

In FIG. 4, the music player 60 has a case 62. On an operating face of the case 62 is provided a display 64, such as a liquid crystal display device, capable of image display and operation buttons 66 for performing various operations, such as tune selection, reproduction, stop, fast forward, rewind, and pause.

On one side of the case 62 is provided the interface connector 22 (see FIG. 5).

As illustrated in FIG. 5, the case 62 contains the interface section 32, an image control section 68, a memory 70, a hard disk drive 72, and a main control section 76.

The image control section 68 generates an image signal based on image data supplied from the main control section 76 and supplies the generated image signal to the display 64 to display an image on the display 64.

The memory 70 includes a RAM that provides a work area and a ROM that stores various data, a control program, the application software for television viewing, etc.

The hard disk drive 72 stores various data including music data that constitutes music contents, and additional data (e.g., text data such as music title data, artist name data, etc.) associated with the music data.

The interface section 32 conducts data exchange based on the USB standard as in the first embodiment. The interface section 32 is connected to the remote control 80 via the interface connector 22 to manage the data exchange.

The main control section 76 includes a CPU that operates based on a program in the ROM of the memory 70, and exercises control over the operation section 66, the image control section 68, the memory 70, the hard disk drive 72, and the interface section 32.

By executing the program in the ROM of the memory 70, the main control section 76 supplies the music data (which corresponds to the first data as recited in the appended claims) and the additional data (which corresponds to the first data as recited in the appended claims) stored in the hard disk drive 72 to the remote control 80 via the interface section 32, the interface connector 22, and the interface cable 44.

In addition, the main control section 76 controls operations of various parts based on the control data (which corresponds to the first data as recited in the appended claims) supplied from an operation section 86 of the remote control 80 via the interface cable 44, the interface connector 22, and the interface section 32.

Moreover, the main control section 76 causes the display 64 to display the image based on the communication data (which corresponds to the second data as recited in the appended claims) supplied from the radio communication section 52 contained in the remote control 80 via the interface cable 44, the interface connector 22, and the interface section 32.

Next, the remote control 80 will now be described below.

As illustrated in FIG. 4, in the present embodiment, the remote control 80 is used to operate the music player 60.

The remote control 80 includes a case 82. The case 82 has connected thereto one end of the interface cable 44. At the other end of interface cable 44 is provided the USB interface connector 46, which is detachably connected to the interface connector 22 of the music player 60.

The case 82 also includes a connector 98 for connection of a plug 96 of headphones 94.

In FIG. 4, the remote control 80 includes a display 84, such as a liquid crystal display device, and operation buttons 86 for performing various operations, such as tune selection, reproduction, stop, fast forward, rewind, and pause. The display 84 and the operation buttons 86 are provided on a front surface of the case 82.

In addition, in FIG. 5, the case 82 of the remote control 80 contains a display control section 88, an audio control section 90, a control section 92, the hub 50, and the radio communication section 52.

The display control section 88 supplies the text data included in the additional data supplied from the control section 92 to the display 84.

The audio control section 90 converts the music data or audio data supplied from the control section 92 into an audio signal and supplies the audio signal to the headphones 94 via the plug 96 to output sound.

The control section 92 exercises control over the operation section 86, the display control section 88, and the audio control section 90.

In addition, the control section 92 receives, via the hub 50, the music data (which corresponds to the first data as recited in the appended claims) and the additional data (which corresponds to the first data as recited in the appended claims) supplied from the music player 60 via the interface cable 44 as USB signals, and supplies the received music data and additional data to the audio control section 90 and the display control section 88, respectively.

Moreover, the control section 92 generates the operation data (which corresponds to the first data as recited in the appended claims) generated by the operation section 86 as a signal based on the USB standard, and supplies the generated signal (i.e., the operation data) to the music player 60 via the hub 50.

As in the first embodiment, the hub 50 has one end of the interface cable 44 connected to, and relays a plurality of types of USB signals.

Note that in the second embodiment, the display 84, the operation section 86, the display control section 88, the audio control section 90, and the control section 92 constitute a main unit as recited in the appended claims.

The radio communication section 52 has significantly the same structure as that of the first embodiment.

The channel selection is performed by the radio communication section 52 when thercontrol section 92 generates the control data based on a user operation performed on the operation section 86 and supplies the generated control data to the RF circuit 52C.

Note that the radio communication section 52 may operate, receiving power (i.e., so-called bus power) from the music player 60 via the interface cable 44 and the USB hub 50. Alternatively, it may be so arranged that a battery is provided within the remote control 80 and that power is supplied from the buttery to the radio communication section 52.

Next, an operation will now be described below.

When the remote control 80 is used as an ordinary remote control, the interface connector 46 of the remote control 80 is connected to the interface connector 22 of the music player 60.

At this time, the control program is running on the music player 60.

If, in this situation, the remote control 80 is operated, the operation data is supplied from the remote control 80 to the music player 60 to play the music content, for example.

When the remote control 80 is used as a TV tuner, the interface connector 46 of the remote control 80 is similarly connected to the interface connector 22 of the music player 60.

At this time, the application software for television viewing is running on the music player 60.

In this situation, the user operates the operation section 86 of the remote control 80 to supply the control data to the radio communication section 52 to select a desired television station.

The radio communication section 52 generates reception data based on a received broadcasting radio wave, and supplies image data included in the reception data to the music player 60 via the interface cable 44, and supplies audio data included in the reception data to the control section 92.

The main control section 76 of the music player 60 supplies the image data supplied via the interface cable 44 and the interface section 32 to the image control section 68.

The image control section 68 generates the image signal based on the image data and supplies the generated image signal to the display 64, so that an image of a television broadcast is displayed.

Meanwhile, the audio control section 90 of the remote control 80 generates the audio signal based on the audio data and supplies the generated audio signal to the headphones 94, so that sound of the television broadcast is outputted.

Here, the image control section 68, the interface section 32, and the main control section 76, which form a part of the music player 60, include the CPU or an LSI, which causes noise as with the first embodiment.

In the case of the remote control 80 according to the second embodiment, however, as in the first embodiment, the radio communication section 52 is contained not in the music player 60 but in the case 82, which is located at a distance from the music player 60. Accordingly, the effect on the radio communication section 52 of the noise caused in the music player 60 is reduced. This contributes greatly to maintaining a high C/N ratio of the radio communication section 52. As a result, the television broadcast can be enjoyed with excellent sound and image quality.

Moreover, as in the first embodiment, the communication data and the control data can be transferred via the interface cable 44 based on the general interface standard, and there is not a need for a dedicated hardware or software component, which contributes to reducing the cost. Further, since the remote control 80 can be connected to any electronic device that complies with the general interface standard, the remote control 80 is highly versatile.

Note that in the above-described embodiments, the USB is adopted as an exemplary general interface standard. However, the general interface standard is not limited to the USB, but may be any standardized interface standard. Examples of such interface standards include: IEEE 1394, which is a standard interface standard for digital video cameras and digital video recorders; a standard interface standard for PC cards; and standard interface standards for various types of memory cards.

Also note that in the above-described embodiment, the antenna 52A of the radio communication section 52 is contained within the case 82 of the remote control 80. However, the antenna 52A may be incorporated into the interface cable 44. In other words, it may be so arranged that a linear antenna wire is arranged inside an outer sheath (an insulator) of the interface cable 44 so as to extend along the length of the interface cable 44 and that one end of the antenna wire is connected to the filter 52B. In this case, an antenna element can be as long as the interface cable 44 at a maximum, which further contributes to improving the reception sensitivity and the C/N ratio when receiving a radio wave of a long wavelength used for television broadcasting or radio broadcasting, such as a radio wave in the VHF band or in the UHF band.

Moreover, it may be so arranged that both the chip antenna contained in the case of the peripheral device and the antenna incorporated in the interface cable are provided, and that the radio communication section 52 carries out so-called diversity reception by switching between the two antennas. This further contributes to improving the reception sensitivity and the C/N ratio.

Also note that in the above-described embodiments, the mouse 40 connected to the personal computer 10 and the remote control 80 connected to the music player 60 are adopted as exemplary peripheral devices. However, the present invention is widely applicable to various peripheral devices that are connected to electronic devices that perform data exchange based on the general interface standard.

Examples of such electronic devices include a personal digital assistant (PDA), a digital still camera, a video camera, and a mobile phone. Examples of such peripheral devices include remote controls, accessories, adapters, etc., for such electronic devices.

Also note that in the above-described embodiments, the radio communication section is the tuner for receiving the television broadcast. However, the radio communication section according to the present invention is not limited to such a tuner. For example, the radio communication section may be a unit for receiving a radio broadcast composed of only audio data. Further, the radio communication section may be, instead of a unit for performing only reception, a unit for performing only transmission or a unit for performing both transmission and reception, such as a unit for implementing a wireless LAN, a wireless PAN, a wireless MAN, or a wireless WAN, for example.

It should be understood by those skilled in the art that various modifications, combinations, sub-combinations and alterations may occur depending on design requirements and other factors insofar as they are within the scope of the appended claims or the equivalents thereof.

What is claimed is:

1. A peripheral device connected to an electronic device via an interface cable for exchanging first data with the electronic device via the interface cable based on a general interface standard, the peripheral device comprising:
a radio communication section configured to perform radio communication with an outside and exchange second data relating to the radio communication with the electronic device via the interface cable based on the general interface standard.

2. The peripheral device according to claim 1, further comprising a main unit configured to implement a predetermined function by exchanging the first data with the electronic device.

3. The peripheral device according to claim 2, wherein,
said peripheral device is a mouse for operating a personal computer, and
the first data includes operation data for operating the personal computer, the operation data being generated by said main unit when the mouse is manipulated.

4. The peripheral device according to claim 2, wherein,
said peripheral device is a remote control for operating a music player, and
the first data includes operation data for operating the music player, the operation data being generated by said main unit when the remote control is manipulated.

5. The peripheral device according to claim 1, wherein,
the radio communication performed by said radio communication section is reception of a broadcasting radio wave transmitted from a broadcast station,
said radio communication section includes a reception section configured to demodulate the received broadcasting radio wave to obtain reception data, and the second data includes the reception data.

6. The peripheral device according to claim 5, wherein the broadcasting radio wave is a broadcasting radio wave of one-segment broadcasting in terrestrial digital broadcasting.

7. The peripheral device according to claim 5, wherein the reception data includes either or both of image data and audio data.

8. The peripheral device according to claim 1, wherein the radio communication performed by said radio communication section is radio communication for implementing one of a wireless LAN, a wireless PAN, a wireless MAN, and a wireless WAN.

9. The peripheral device according to claim 1, wherein an antenna configured to perform either or both of reception and transmission of a radio wave when said radio communication section performs the radio communication with the outside is contained within said peripheral device or incorporated in the interface cable.

10. The peripheral device according to claim 1, wherein the general interface standard is either a USB standard or an IEEE 1394 standard.

11. The peripheral device according to claim 1, wherein the general interface standard is an interface standard for a PC card.

12. The peripheral device according to claim 1, wherein the general interface standard is an interface standard for a memory card.
